(19) United States
(12) Patent Application Publication
(10) Pub. No.: US 2009/0154616 A1
(43) Pub. Date: Jun. 18, 2009

(54) RESIDUAL FREQUENCY OFFSET COMPENSATION APPARATUS USING PHASE SHIFT COMPENSATION SCHEME

(76) Inventors: Eun Sook JIN, Daejeon (KR); Yun Jeong SONG, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/333,712

(22) Filed: Dec. 12, 2008

(30) Foreign Application Priority Data
Dec. 13, 2007 (KR) 10-2007-0129685

(51) Int. Cl. H04L 27/06

(52) U.S. Cl. 375/344

(57) ABSTRACT

A residual frequency offset compensation apparatus is provided. The residual frequency offset compensation apparatus includes: a basic phase offset compensation unit compensating input symbols using a previously stored basic phase offset and generating first symbols; a phase shift calculation unit calculating a phase shift value of each of a predetermined number of the first symbols using first detection symbols and the first symbols, the first detection symbols being generated by detecting the first symbols; a phase shift compensation unit compensating the first symbols based on an average of the phase shift values; and a basic phase offset update unit updating the basic phase offset based on the phase shift values.

### CROSS-REFERENCE TO RELATED APPLICATION

This application claims priority from Korean Patent Application No. 10-2007-0129685, filed on Dec. 13, 2007, in the Korean Intellectual Property Office, the entire disclosure of which is incorporated herein by reference.

### BACKGROUND OF THE INVENTION

1. Field of the Invention

The present invention relates to a technology compensating a signal received in a receiving end in a communication system, and more particularly, to a technology compensating a residual frequency offset.

This work was supported by the IT R&D program of MIC/IITA. [2006-S-019-02, The Development of Digital Cable Transmission and Receive System for 1 Gbps Downstream]

2. Description of Related Art

In general communication systems, a transmitting end transmits a signal divided into a preamble portion and data portion. A preamble portion includes a preamble used for synchronization, and a data portion includes information to be actually transmitted.

Generally, a preamble portion includes symbols for Symbol Timing Recovery (STR), Carrier Frequency Recovery (CFR), and Carrier Phase Recovery (CPR) for synchronization of data portion or identification of a start point of a signal. Also, a data portion includes symbols for information to be actually transmitted.

Symbols included in STR are used to estimate a timing offset and accurate synchronization. Symbols included in CFR are used to estimate and compensate a frequency offset generated since a frequency band of a transmitting end is not the same as a frequency band of a receiving end. Symbols included in CPR are used to remove a phase offset generated while a signal is transmitted. Accordingly, a receiving end may detect symbols included in a data portion more precisely using symbols included in a preamble portion.

However, although symbols included in a preamble portion are used, a timing offset, frequency offset, and phase offset may not be completely compensated due to noise and frequently changed channel state. In particular, symbols included in a data portion has a phase shift due to a residual frequency offset generated since a frequency offset may not be accurately estimated and compensated. In this case, a phase shift of symbols included in a data portion increases as a length of data portion increases. Accordingly, a performance of receiver may be significantly degraded.

Two methods have been mainly used to overcome a residual frequency offset. In the first method, a plurality of pilot symbols is inserted in a data portion. In the second method, a burst length and preamble length are controlled depending on a channel state. In the first and second method, as the number of inserted pilot symbols increases, a data transmission rate may decrease and a preamble length may unnecessarily become longer in comparison to a length of data portion.

Also, the first and second method may not be applied to symbols generated according to a High Order Quadrature Amplitude Modulation (QAM), since the symbols are significantly affected by a residual frequency offset.

Thus, a residual frequency offset compensation apparatus which may be efficiently applied to symbols generated according to a high order QAM without decreasing a data transmission rate is required.

### SUMMARY OF THE INVENTION

An aspect of the present invention provides a residual frequency offset compensation apparatus which updates a basic phase offset based on a phase shift value, and is applied to symbols generated according to a high order Quadrature Amplitude Modulation (QAM), and thereby may efficiently compensate a residual frequency offset.

Another aspect of the present invention also provides a residual frequency offset compensation apparatus which compensates a residual frequency offset using a basic phase offset which may be accumulatively increased, and thereby may efficiently compensate the residual frequency offset even when a length of data portion increase.

Another aspect of the present invention also provides a residual frequency offset compensation apparatus which may compensate a residual frequency offset without decreasing a data transmission rate.

According to an aspect of the present invention, there is provided a residual frequency offset compensation apparatus, including: a basic phase offset compensation unit compensating input symbols using a previously stored basic phase offset and generating first symbols; a phase shift calculation unit calculating a phase shift value of each of a predetermined number of the first symbols using first detection symbols and the first symbols, the first detection symbols being generated by detecting the first symbols; a phase shift compensation unit compensating the first symbols based on an average of the phase shift values; and a basic phase offset update unit updating the basic phase offset based on the phase shift values.

According to another aspect of the present invention, there is provided a residual frequency offset compensation apparatus, including: a basic phase offset compensation unit compensating a first input symbol using a previously stored basic phase offset and generating a first compensation symbol; a phase shift calculation unit calculating a phase shift value of the first compensation symbol using a first detection symbol and the first compensation symbol, the first detection symbol being generated by detecting the first compensation symbol; a phase shift compensation unit compensating the first compensation symbol using the phase shift value; and a basic phase offset update unit updating the basic phase offset based on the phase shift value, wherein the basic phase offset compensation unit compensates a second input symbol based on the updated basic phase offset, the second input symbol being different from the first input symbol.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating symbols modulated according to a 16 Quadrature Amplitude Modulation (QAM) according to an embodiment of the present invention;

FIG. 2 is a diagram illustrating an estimated phase shift which may be estimated with respect to an actual phase shift when symbols are modulated according to a 16 QAM;

FIG. 3 is a block diagram illustrating a residual frequency offset compensation apparatus according to an embodiment of the present invention;

FIG. 4 is a flowchart illustrating an operation method of a residual frequency offset compensation apparatus according to an embodiment of the present invention; and

FIG. 5 is a diagram illustrating an estimated phase shift which may be estimated with respect to an actual phase shift when symbols are modulated according to a 16 QAM according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

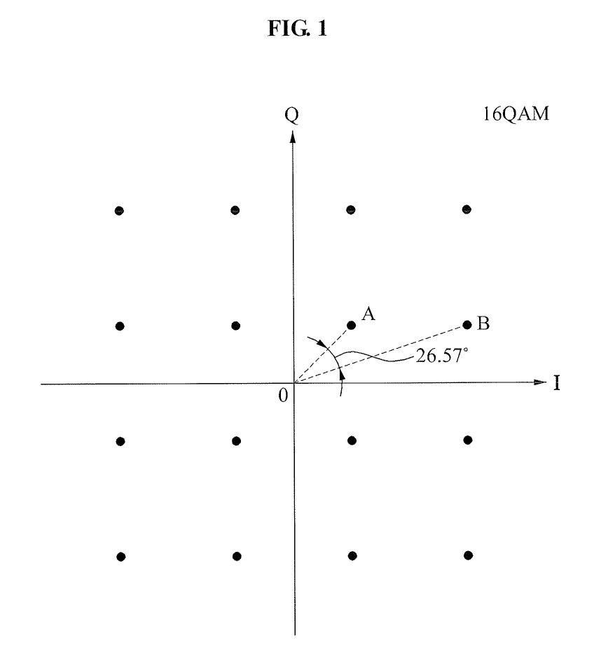

FIG. 1 is a diagram illustrating symbols modulated according to a 16 Quadrature Amplitude Modulation (QAM) according to an embodiment of the present invention.

Referring to FIG. 1, 16 points indicate symbols which may be modulated and generated according to the 16 QAM. According to the 16 QAM, four-bit data is mapped to any one of the 16 symbols and modulated.

When a residual frequency offset exists, a phase of symbols detected by a receiving end is different from a phase of symbols modulated by a transmitting end due to the residual frequency offset, even though the transmitting end transmits symbols modulated according to the 16 QAM. In particular, a phase shift due to the residual frequency offset increases over time. Accordingly, when the length of data portion increases, symbols detected by the receiving end may include a number of errors.

Also, when the transmitting end generates symbols according to a high order QAM such as the 16 QAM, an angle between symbols adjacent to each other may decrease. In this instance, a minimum value of angles between symbols adjacent to each other is significant, which is described below. As illustrated in FIG. 1, a minimum value of angles between adjacent symbols A and B with respect to symbols generated according to the 16 QAM is approximately 26.57 degrees.

Specifically, the minimum value of the angles between the symbols adjacent to each other is significant. For example, it is assumed that a phase shift of the symbol B is +15 degrees greater than about +13.28 degrees corresponding to a half of +26.57 degrees. The phase shift of the symbol B is generated due to the residual frequency offset, and (+) indicates a counterclockwise direction.

A receiver may not estimate that a received symbol B is rotated by +15 degrees from the symbol B, transmitted from a transmitter, in a counterclockwise direction. That is, the receiver may not estimate and compensate a phase shift with respect to the received symbol B by assuming the transmitted symbol B as a reference symbol. The receiver may calculate a phase offset with respect to the received symbol B using a transmitted symbol A as the reference symbol. In this case, the receiver estimates an incorrect phase shift, and disadvantages described above may occur.

When the high order QAM is used, the angle between symbols adjacent to each other may decrease, and the reference symbol to estimate the phase shift may not be determined. Accordingly, the phase shift may not be precisely estimated.

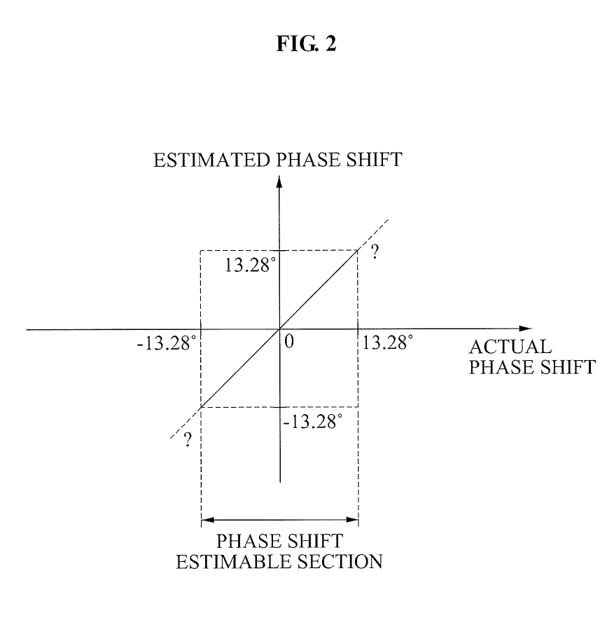

FIG. 2 is a diagram illustrating an estimated phase shift which may be estimated with respect to an actual phase shift when symbols are modulated according to a 16 QAM.

Referring to FIG. 2, as described with reference to FIG. 1, a minimum value of angles between symbols adjacent to each other with respect to symbols generated according to a 16 QAM is about 26.57 degrees, and +13.28 degrees and −13.28 degrees are illustrated in FIG. 2. +13.28 degrees and −13.28 degrees correspond to a half of the minimum value.

When a magnitude of an actual phase shift is less than 13.28 degrees, a reference symbol, which is a reference when a receiver measures an actual phase shift, does not change. Theoretically, the receiver may precisely measure the phase shift.

However, when the magnitude of the phase shift is greater than 13.28 degrees, a reference symbol, which is a reference when the receiver measures the phase shift, changes. Accordingly, the receiver may not precisely measure the phase shift. The receiver may precisely measure the phase shift only when the actual phase shift is less than 13.28 degrees. Thus, a length of data portion which may be used may be limited and a Bit Error Rate (BER) may increase.

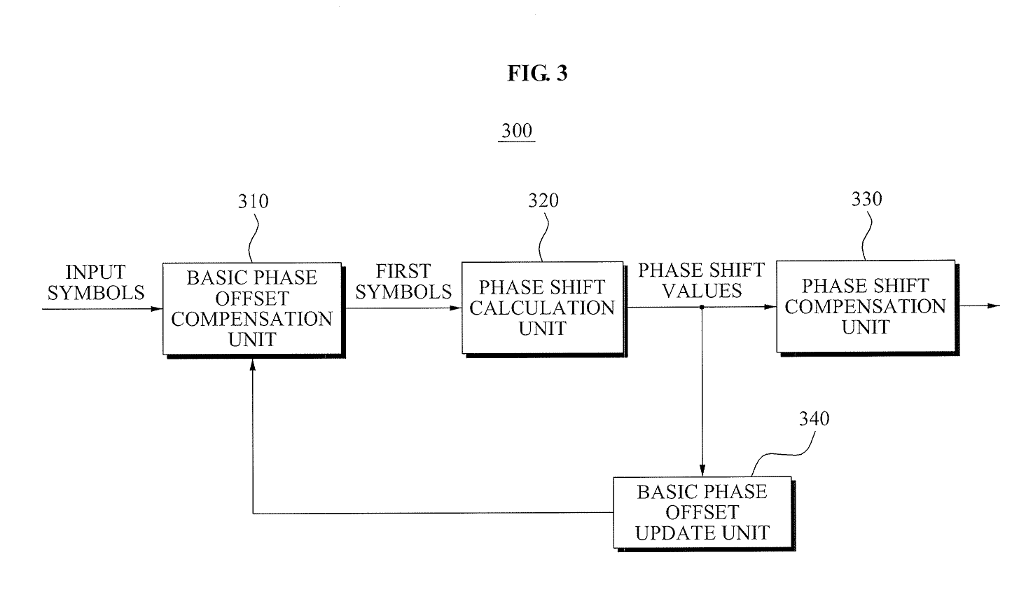

According to an embodiment of the present invention, however, a basic phase offset increases according to an increase of the magnitude of the actual phase shift. Accordingly, the phase shift may be estimated more accurately, which is described with reference to FIGS. 3 through 5.

FIG. 3 is a block diagram illustrating a residual frequency offset compensation apparatus 300 according to an embodiment of the present invention.

Referring to FIG. 3, the residual frequency offset compensation apparatus 300 includes a basic phase offset compensation unit 310, phase shift calculation unit 320, phase shift compensation unit 330, and basic phase offset update unit 340.

The basic phase offset compensation unit 310 compensates input symbols using a previously stored basic phase offset and generates first symbols. An initial state of the basic phase offset may be a zero state. A magnitude of the basic phase offset increases as a magnitude of an actual phase shift increases, which is described below.

According to an embodiment of the present invention, the basic phase offset compensation unit 310 compensates the input symbols in advance to enable a phase shift of the first symbols to be included in an estimable section all the time. Accordingly, even when a length of data portion becomes longer, the phase shift may be efficiently estimated and compensated.

The phase shift calculation unit 320 detects the first symbols and generates first detection symbols. Also, the phase shift calculation unit 320 calculates a phase shift value of each of a predetermined number of the first symbols using the first detection symbols and first symbols.

The first symbols are signals where the basic phase offset with respect to the input symbols is compensated. In this instance, a phase difference of each of the first detection symbols and first symbols may be calculated as the phase shift values.

The phase shift calculation unit 320 may perform a conjugate operation with respect to any one of the first detection symbols and first symbols to calculate the phase shift values.

For example, when it is assumed that the first symbols are x, y, and z, and the first detection symbols are x′, y′, and z′, a conjugate value of each of the first detection symbols, (x′)*, (y′)*, and (z′)*, may be calculated. When multiplying x and (x′)*, y and (y′)*, and z and (z′)*, respectively, x(x′)*, y(y′)*, and z(z′)* may be calculated. The phase shift calculation unit 320 may calculate a phase of each of x(x′)*, y(y′)*, and z(z′)* as the phase shift values.

The phase shift compensation unit 330 may compensate the first symbols using an average of the calculated phase shift values. In an example described above, it is assumed that the phase of each of x(x′)*, y(y′)*, and z(z′)* is a, b, and c. A phase of (a+b+c)/3 may be compensated with respect to each of the first symbols, x, y, and z.

The basic phase offset update unit 340 updates the basic phase offset based on the phase shift values.

The basic phase offset update unit 340 may update the basic phase offset based on a maximum phase shift value of the phase shift values. The basic phase offset update unit 340 may update the basic phase offset based on a magnitude of the maximum phase shift value of the phase shift values and signs of the phase shift values. The magnitude of the maximum phase shift value is associated with estimable phase shift values, and the signs of the phase shift values are associated with a direction of phase shift.

In the example described above, it is assumed that a maximum value of the phase shift values, a, b, and c, is c, and the phase shift values, a, b, and c are greater than 0. In this instance, when c is greater than a predetermined threshold value, the basic phase offset update unit 340 may increase the basic phase offset by a predetermined angle. The threshold value may be determined in advance according to a modulation scheme of the input symbols.

Specifically, it is assumed that the input symbols are generated according to a 16 QAM, and the threshold value is previously determined as 11 degrees which has a margin with respect to 13.28 degrees. When the maximum phase shift value c is greater than 11 degrees, the basic phase offset update unit 340 may increase the magnitude of the basic phase offset to enable phase shift values of first symbols, generated later, to be less than 13.28 degrees, as described with reference to FIGS. 1 and 2. For example, the basic phase offset update unit 340 may increase a magnitude of a currently stored basic phase offset up to 13.28 degrees.

According to an embodiment of the present invention, the magnitude of the basic phase offset accumulatively and sequentially increases according to an increase of an actual phase shift, and thus the phase shift may be precisely measured.

The basic phase offset update unit 340 may increase the basic phase offset by a predetermined angle according to the modulation scheme of the input symbols. As a QAM order of the input symbols increases, an angle between symbols adjacent to each other decreases, and a section of estimable phase offset becomes narrower. Accordingly, the basic phase offset update unit 340 may increase the basic phase offset by a smaller angle as the QAM order becomes higher.

According to an embodiment of the present invention, although the actual phase offset increases since a length of data portion becomes longer, the basic phase offset increases. Thus, the phase shift values of the first symbols may be always maintained within a fixed range, and the phase offset may be estimated and compensated more precisely and efficiently.

As described above, the basic phase offset with respect to the plurality of input symbols may be compensated, and the phase shift may be estimated using the phase shift values and the average of phase shift values.

According to an embodiment of the present invention, an operation principle of the residual frequency offset compensation apparatus described above may be applied to a single input symbol.

When the residual frequency offset compensation apparatus according to the present invention is applied to a plurality of input symbols, a plurality of phase shift values are generated as described above. Accordingly, an operation of calculating an average of the phase shift values and operation of extracting a maximum phase shift value are required. However, when the residual frequency offset compensation apparatus according to the present invention is applied to the single input symbol, the operation of calculating the average of the phase shift values and operation of extracting a maximum phase shift value are not required. The residual frequency offset compensation apparatus according to the present invention may be applied identically with respect to the plurality of input symbols and single input symbols, other than the operations described above.

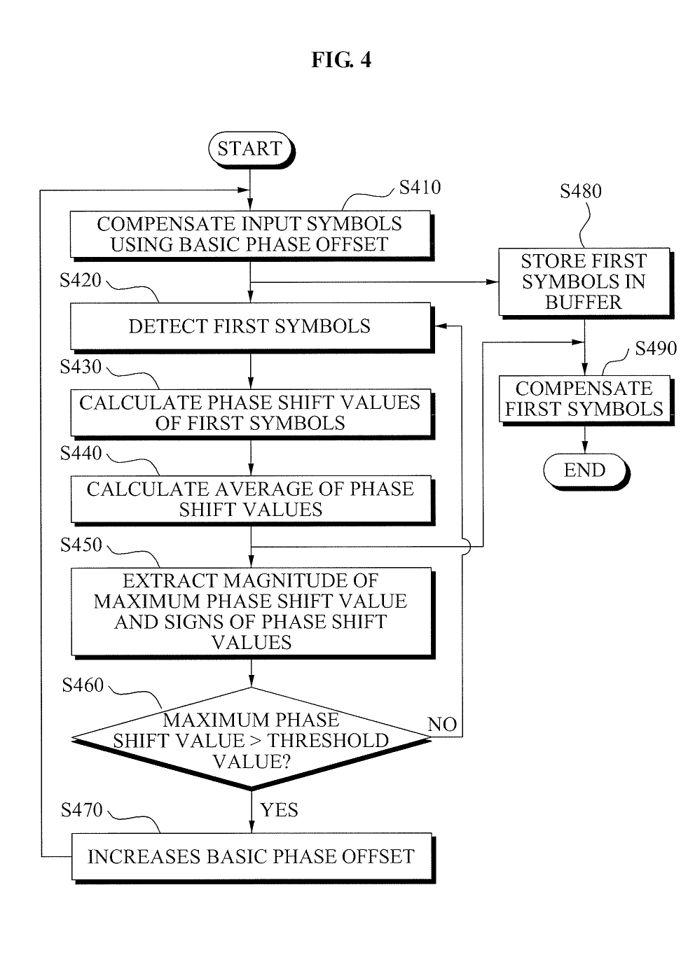

FIG. 4 is a flowchart illustrating an operation method of a residual frequency offset compensation apparatus according to an embodiment of the present invention.

Referring to FIG. 4, in operation S410, the residual frequency offset compensation apparatus compensates input symbols using a previously stored basic phase offset and generates first symbols.

In operation S420, the residual frequency offset compensation apparatus detects the first symbols and generates first detection symbols.

In operation S430, the residual frequency offset compensation apparatus calculates a phase shift value of each of a predetermined number of the first symbols using the first detection symbols and first symbols.

In operation S440, the residual frequency offset compensation apparatus calculates an average of the phase shift values.

In operation S480, the residual frequency offset compensation apparatus stores the first symbols generated in operation S410 in a buffer. In operation S490, the residual frequency offset compensation apparatus compensates the first symbols using the average calculated in operation S440.

In operation S450, the residual frequency offset compensation apparatus extracts a magnitude of a maximum phase shift value of the phase shift values and signs of the phase shift values.

In operation S460, the residual frequency offset compensation apparatus determines whether the magnitude of the maximum phase shift value is greater than a predetermined threshold value.

In operation S470, the residual frequency offset compensation apparatus increases the basic phase offset by a predetermined angle when the magnitude of the maximum phase shift value is greater than the predetermined threshold value.

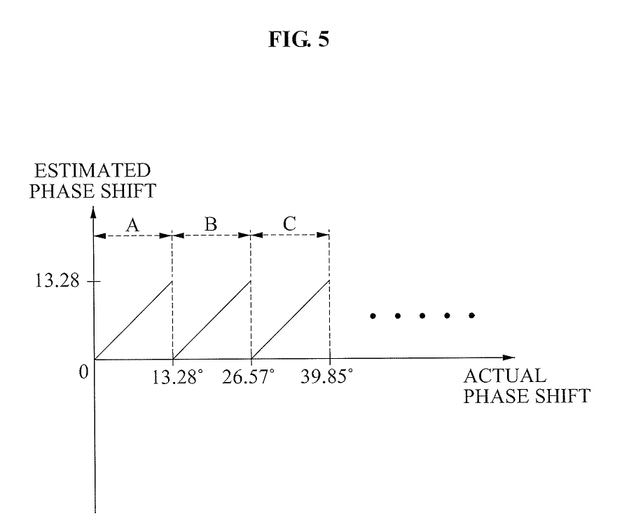

FIG. 5 is a diagram illustrating an estimated phase shift with respect to an actual phase shift when symbols are modulated according to a 16 QAM according to an embodiment of the present invention.

Referring to FIG. 5, it may be ascertained that a magnitude of the estimated phase shift is always less than 13.28 degrees although the actual phase shift continuously increases. However, the magnitude of the estimated phase shift is less than 13.28 degrees all the time since a phase shift with respect to symbols where a basic phase offset is compensated in advance is estimated, not since the actual phase shift is incorrectly estimated.

Specifically, although the actual phase shift increases as a length of data portion becomes longer, the basic phase offset is sequentially updated according to the increase of the actual phase shift. Accordingly, the magnitude of the estimated phase shift is always less than 13.28 degrees.

When a basic phase offset applied in a section A is X, a basic phase offset applied in a section B may be X+y, and a basic phase offset applied in a section C may be X+2y.

Thus, according to an embodiment of the present invention, in a case of 16 QAM, an estimation error generated when the actual phase shift described with reference to FIGS. 1 and 2 is greater than 13.28 degrees may be prevented.

The operation method of a residual frequency offset compensation apparatus according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, a residual frequency offset compensation apparatus updates a basic phase offset based on a phase shift value, and is applied to symbols generated according to a high order Quadrature Amplitude Modulation (QAM), and thereby may efficiently compensate a residual frequency offset.

Also, according to the present invention, a residual frequency offset compensation apparatus compensates a residual frequency offset using a basic phase offset which may accumulatively increase, and thereby may efficiently compensate the residual frequency offset even when a length of data portion increase.

Also, according to the present invention, a residual frequency offset compensation apparatus may compensate a residual frequency offset without decreasing a data transmission rate.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A residual frequency offset compensation apparatus, comprising:
a basic phase offset compensation unit compensating input symbols using a previously stored basic phase offset and generating first symbols;
a phase shift calculation unit calculating a phase shift value of each of a predetermined number of the first symbols using first detection symbols and the first symbols, the first detection symbols being generated by detecting the first symbols;
a phase shift compensation unit compensating the first symbols based on an average of the phase shift values; and
a basic phase offset update unit updating the basic phase offset based on the phase shift values.

2. The residual frequency offset compensation apparatus of claim 1, wherein the basic phase offset update unit increases the basic phase offset by a predetermined angle according to a modulation scheme of the input symbols.

3. The residual frequency offset compensation apparatus of claim 1, wherein the basic phase offset update unit updates the basic phase offset based on a maximum phase shift value of the phase shift values.

4. The residual frequency offset compensation apparatus of claim 1, wherein the basic phase offset update unit updates the basic phase offset based on a magnitude of a maximum phase shift value of the phase shift values and signs of the phase shift values.

5. The residual frequency offset compensation apparatus of claim 1, wherein the basic phase offset update unit updates the basic phase offset based on whether a magnitude of a maximum phase shift value of the phase shift values is greater than a predetermined threshold value.

6. The residual frequency offset compensation apparatus of claim 5, wherein the basic phase offset update unit increases the basic phase offset by a predetermined angle depending on signs of the phase shift values, when the magnitude of the maximum phase shift value is greater than the threshold value.

7. The residual frequency offset compensation apparatus of claim 5, wherein the threshold value is determined in advance according to a modulation scheme of the input symbols.

8. The residual frequency offset compensation apparatus of claim 1, wherein an initial state of the basic phase offset is a zero state.

9. The residual frequency offset compensation apparatus of claim 1, wherein the phase shift calculation unit performs a conjugate operation with respect to any one of the first detection symbols and first symbols.

10. A residual frequency offset compensation apparatus, comprising:
a basic phase offset compensation unit compensating a first input symbol using a previously stored basic phase offset and generating a first compensation symbol;
a phase shift calculation unit calculating a phase shift value of the first compensation symbol using a first detection symbol and the first compensation symbol, the first detection symbol being generated by detecting the first compensation symbol;
a phase shift compensation unit compensating the first compensation symbol using the phase shift value; and
a basic phase offset update unit updating the basic phase offset based on the phase shift value,
wherein the basic phase offset compensation unit compensates a second input symbol based on the updated basic phase offset, the second input symbol being different from the first input symbol.

11. The residual frequency offset compensation apparatus of claim 10, wherein the basic phase offset update unit updates the basic phase offset based on a sign of the phase shift value and whether the phase shift value is greater than a predetermined threshold value.

12. The residual frequency offset compensation apparatus of claim 10, wherein the basic phase offset update unit updates the basic phase offset by a predetermined angle according to a modulation scheme of the first input symbol.

13. The residual frequency offset compensation apparatus of claim 10, wherein the phase shift calculation unit performs a conjugate operation with respect to any one of the first detection symbol and first compensation symbol to calculate the phase shift value.
